(19) United States
(12) Patent Application Publication
(10) Pub. No.: US 2014/0261230 A1
(43) Pub. Date: Sep. 18, 2014

(54) PET COLLAR TOY

(71) Applicant: Maze Innovations, Inc., Montreal, MO (US)

(72) Inventors: George McConnell Davison, III, Pittsburgh, PA (US); Peter Arthur Meier, Fenelton, PA (US); Jason Reed Rogge, Belle Vernon, PA (US); Colin Derek Curry, Allison Park, PA (US); Matthew David McClatchey, Harwick, PA (US)

(73) Assignee: Maze Innovations, Inc., Montreal, MO (US)

(21) Appl. No.: 14/218,031

(22) Filed: Mar. 18, 2014

Related U.S. Application Data
(60) Provisional application No. 61/802,811, filed on Mar. 18, 2013.

(51) Int. Cl. A01K 15/02

(52) U.S. Cl. CPC A01K 15/025
USPC 119/707

(57) ABSTRACT

A pet toy is attached to a pet collar and emits a point of light on a distal surface in front of the animal to provide entertainment to the animal. The pet toy preferably comprises a small housing suitable for attachment to an existing collar, wherein the housing contains a light source, a power source and an electronic control circuit. The toy preferably allows for either a constant or an intermittent display of the light based on user selection, and further preferably includes a timing circuit to allow for automatic deactivation of the light source after a predetermined period of operation. The light source may, for instance, be a laser or a light emitting diode.

### PRIORITY CLAIM

This application is a nonprovisional of, and claims priority from, U.S. Provisional Patent App. Ser. No. 61/802,811, filed Mar. 18, 2013, the contents of which are hereby incorporated herein by reference in their entirety.

### BACKGROUND OF THE INVENTIVE CONCEPTS

The present inventive concepts relate to pet toys, in general, and specifically to pet toys constructed and adapted for attachment to a collar worn around the animal's neck. Pet toys are a common item in the prior art. Many toys incorporate a bobble, dangle, or similar small item that is readily moved in an erratic fashion to attract and entertain the animal. Many such toys also incorporate a light, directing a small point of light at various objects to allow the animal to chase the spot of light.

### BRIEF SUMMARY OF THE INVENTIVE CONCEPTS

It is an object of the present inventive concepts to provide a device to display a small point of light in an erratic manner to provide a source of attraction and entertainment to the animal.

It is further an object of the present inventive concepts to provide a lighted toy that is attachable to an existing collar worn around the animal's neck, or which may be directly implemented into a pet collar.

It is still further an object of the present inventive concepts to provide a lighted toy which is capable of displaying the light object in either a constant or an intermittent manner based on a random determination or user selection.

It is still further an object of the present inventive concepts to provide a lighted toy which deactivates after a pre-determined period of time.

The present inventive concepts provide a pet toy constructed and adapted to provide a laser light which directs a point of light on a surface in front of the animal to provide entertainment to the animal The pet toy may, for example, be attached to an existing collar or may be integrally implemented into a pet collar.

In one embodiment, the pet toy may comprise a housing, with the housing having a defined front and rear surface. An attachment can be provided on or near the rear surface of the housing to allow the housing to attach to an existing animal collar of the type worn around the animal's neck. The attachment may, for example, be a narrow slit, clip, or any other type of attachment that allows the housing to be attached to the collar. A laser (or other light source) is contained within the housing and is positioned to direct light outwardly from the front of the housing onto a distal surface. A power supply, such as a battery, is also preferably contained within the housing.

Control circuitry, such as electronic wiring and components arranged, for example, on an electrical circuit board, may be operable from the exterior of the housing (i.e., through an external button or remote control device) to control the application of power to the laser. The circuitry may optionally provide the ability to display either a constant beam of light or an intermittent beam of light, based, for example on random selection or user selection. Further optionally, the circuitry may include a timing mechanism to deactivate the laser after a pre-determined period of operation.

Various aspects, embodiments, and configurations of the inventive concepts are possible without departing from the principles disclosed herein. The inventive concepts are therefore not limited to any of the particular aspects, embodiments, or configurations described herein.

### BRIEF DESCRIPTION OF DRAWINGS

The foregoing and additional objects, features, and advantages of the present inventive concepts will become more readily apparent from the following detailed description of preferred embodiments, made with reference to the accompanying drawings, in which:

FIG. 1 is a somewhat schematic left-side exploded perspective view of a pet toy according to various principles of the present inventive concepts;

FIG. 2 is a somewhat schematic right-side perspective view of the pet toy of FIG. 1, shown fully assembled and attached to a pet collar;

FIG. 3 is a somewhat schematic left-side perspective view of the pet toy of FIG. 1, again shown fully assembled and attached to a pet collar;

FIG. 4 is a somewhat schematic perspective view of a cat wearing the pet toy of FIG. 1 on its collar, according to an aspect of the present inventive concepts; and.

FIG. 5 is a somewhat schematic perspective view of a dog wearing the pet toy of FIG. 1 on its collar, according to another aspect of the present inventive concepts.

### DETAILED DESCRIPTION OF THE INVENTIVE CONCEPTS

Various features, benefits, and configurations incorporating principles of the present inventive concepts in illustrative embodiments are shown in the accompanying drawings. Additional features, benefits and configurations will be readily apparent to those of ordinary skill in the art based on this disclosure, and all such features, benefits and configurations are considered to be within the scope of the present inventive concepts. Various embodiments will now be described in connection with the drawings.

FIG. 1 is a somewhat schematic left-side exploded perspective view of a pet toy 1 according to principles of the present inventive concepts, shown in a preferred embodiment. In FIG. 1, the various components of this embodiment of the device are shown separated from each other for ease of explanation. FIG. 2 is a somewhat schematic right-side perspective view of the pet toy 1 of FIG. 1, shown fully assembled and attached to a pet collar 100. FIG. 3 is a somewhat schematic left-side perspective view of the pet toy 1 of FIG. 1, again shown fully assembled and attached to a pet collar 100. FIG. 4 is a somewhat schematic perspective view of an animal (cat) 120 wearing the pet toy 1 of FIG. 1 on its collar 100, according to an aspect of the present inventive concepts. And FIG. 5 is a somewhat schematic perspective view of another animal (dog) 120 wearing the pet toy 1 of FIG. 1 on its collar 100, according to another aspect of the present inventive concepts.

Referring to FIGS. 1-5, a laser/light pet toy 1, configured to be attached to a pet collar 100, may contain a housing 8 consisting of various parts. In this embodiment, for example, the housing comprises a molded plastic container having a top portion 10 and a bottom portion 13. The top portion 10 may include a rear attachment 11 configured to secure the housing to an existing animal collar 100. As shown in FIG. 1, the attachment 11 may, for example, be a clip. However, any appropriate attachment that permits the pet toy 1 to be secured to a pet collar 100 may be used and is within the scope of the inventive concepts.

The top portion also preferably comprises a contact plate 12 which, in conjunction with an external button 50, can be configured to operate as a switch to control application of power to the electronic components of the device 1. Additionally, or alternatively, a remote control device could be provided to control operation of the pet toy 1. The lower portion of the housing 13 has an opening 14 configured to receive and hold the laser/light source 20 in a manner that directs the light away from the animal and onto a distal surface when the toy is attached to a collar 100 worn by the animal 120.

A battery holder or other power supply retention device 31 is preferably positioned between the upper and lower portions 10, 13, respectively, of the housing 10. The battery holder 31 preferably holds a portable power source, such as a battery 30, in contact with electrical contacts (not shown) of the electronic circuitry 40. The electronic circuitry 40 is preferably positioned in electrical communication with the power source 30 and the laser/light source 20.

The electronic circuitry 40 is preferably configured to control delivery of power from the battery 30 to the laser/light source 20. The electronic circuitry 40 may, for instance, allow the selective display of either a constant beam of light or an intermittent beam of light from the toy. The choice between a constant or intermittent display could be based, for example, on a random selection by the electronic circuitry 40 itself, or based on user selection. The electronic circuitry 40 may further comprise a timing mechanism configured to deactivate the laser after a pre-determined period of operation.

According to one embodiment, the laser/light source 20 may be a 4 mW, 650 nm laser operating at 3 VDC@25 mA. However, without deviating from the scope of the present inventive concepts, the light source 20 may be any appropriate light source (for example, a light emitting diode, a laser diode, or other light source) that is capable of projecting a point of light 130 away from the animal 120.

The present inventive concepts have been described with reference to a preferred embodiment thereof It should be readily apparent to those skilled in the art, however, that many changes, variations, modifications, and other uses and applications to the disclosed device are possible, and all such changes, variations, modifications, and other uses and applications which do not depart from the spirit and scope of the inventive concepts disclosed herein should be deemed to be covered by the following claims.

What is claimed is:

1. A pet toy configured to be worn on or attached to a collar of an animal, said pet toy comprising:
a housing comprising an attachment for attaching the pet toy to an animal collar;
a power supply receptacle arranged in the housing and configured to hold a portable power supply;
a light source arranged in the housing and configured to project a point of light away from a front of the housing onto a distal surface; and
an electronic circuit arranged within the housing and configured to receive power from the portable power supply and to selectively supply power from the power supply to the light source to cause the light source to project the point of light.

2. The pet toy of claim 1, wherein the attachment comprises a clip arranged on a rearward portion of the housing and configured to clip onto the animal collar.

3. The pet toy of claim 1, wherein the electronic circuit comprises a timing circuit configured to automatically turn off the light source after a predetermined period of operation.

4. The pet toy of claim 1, further comprising a button arranged on the housing and configured to activate the electronic circuit in response to actuation of the button.

6. The pet toy of claim 1, wherein the housing comprises a top portion and a bottom portion configured to be attached together to form the housing.

7. The pet toy of claim 6, wherein the power supply receptacle is arranged between the top and bottom portions of the housing.

8. The pet toy of claim 6, wherein the light source is arranged in a receptacle located in the bottom portion of the housing, and wherein the bottom portion of the housing comprises an opening arranged through a front of the bottom portion to permit light from the light source to project from the front of the housing onto the distal surface during operation.

9. The pet toy of claim 6, wherein the button comprises a contact plate arranged on the top portion of the housing.

10. The pet toy of claim 1, wherein the electronic circuit is configured to cause the light source to emit a constant beam of light during operation.

11. The pet toy of claim 1, wherein the electronic circuit is configured to cause the light source to emit an intermittent beam of light during operation.

12. The pet toy of claim 1, wherein the electronic circuit is operable to cause the light source to emit either a constant beam of light or an intermittent beam of light during operation.

13. The pet toy of claim 1, wherein the light source comprises a laser.

14. The pet toy of claim 1, wherein the light source comprises a light emitting diode.

15. A pet toy configured to be worn on or attached to a collar of an animal, said pet toy comprising:
a plastic housing comprising a molded top portion and a molded bottom portion configured to be secured together;
an attachment arranged on the top portion for attaching the pet toy to an animal collar;
a power supply receptacle arranged in the housing between the top and bottom portions, and configured to removably hold a portable power supply;
a light source arranged in a receptacle in the bottom portion of the housing and configured to project a point of light onto a distal surface through an opening in a front of the bottom portion of the housing; and
an electronic circuit arranged within the housing and configured to receive power from the portable power supply and to selectively supply power from the power supply to the light source to cause the light source to project the point of light.

16. The pet toy of claim 15, wherein the electronic circuit is operable to cause the light source to emit either a constant beam of light or an intermittent beam of light during operation.

17. The pet toy of claim 15, wherein the light source comprises a laser.

18. A pet toy configured to be worn on, attached to, or form part of a collar of an animal, said pet toy comprising:
a housing configured to house the internal components of the pet toy, said housing configured to be attached to or form part of the animal collar;
a light source arranged in a receptacle in the bottom portion of the housing and configured to project a point of light onto a distal surface through an opening in a front of the bottom portion of the housing; and
an electronic circuit arranged within the housing and configured to receive power from a portable power supply when the portable power supply is operatively arranged in the housing, said electronic circuit configured to selectively supply power from the portable power supply to the light source to cause the light source to project the point of light.

19. The pet toy of claim 18, wherein the electronic circuit is operable to cause the light source to emit either a constant beam of light or an intermittent beam of light during operation based on either random selection by the electronic circuit or user selection.

20. The pet toy of claim 18, wherein the pet toy is remotely operable.
